(19) United States
(12) Patent Application Publication
(10) Pub. No.: US 2009/0303153 A1
(43) Pub. Date: Dec. 10, 2009

(54) ANTENNA APPARATUS

(75) Inventors: Akira Takaoka, Okazaki-city (JP); Noriaki OKADA, Chiryu-city (JP)

Correspondence Address: NIXON & VANDERHYE, PC, 901 NORTH GLEBE ROAD, 11TH FLOOR, ARLINGTON, VA, 22203, US

(73) Assignees: NIPPON SOKEN, INC., Nishio-city (JP); DENSO CORPORATION, Kariya-city (JP)

(21) Appl. No.: 12/478,125

(22) Filed: Jun. 4, 2009

(30) Foreign Application Priority Data
Jun. 4, 2008 (JP) 2008-147342

(51) Int. Cl. H01Q 1/36

(52) U.S. Cl. 343/895

(57) ABSTRACT

An antenna apparatus includes an antenna and support member. The antenna has a double spiral structure to include (i) an outer element, which has a spiral section prolonged spirally in an axial direction, and (ii) an inner element, which has a spiral section prolonged spirally in the axial direction and is surrounded with an interval space by the outer element. The support member is made of dielectrics and holds the two elements in a predetermined positional relationship by contacting the spiral sections of the two elements. The support member contacts the spiral sections wholly along the prolonged direction. One of the two elements is connected with a high frequency wave source at one end portion along the axial direction while the other is connected with the high frequency wave source at the other end portion along the axial direction. The antenna functions as a terminal short circuit type.

### CROSS REFERENCE TO RELATED APPLICATION

The present application is based on and incorporates herein by reference Japanese Patent Application No. 2008-147342 filed on Jun. 4, 2008.

### FIELD OF THE INVENTION

The present invention relates to an antenna apparatus using a dielectric member, in particular, for a keyless remote system or smart entry system in a vehicle or residence.

### BACKGROUND OF THE INVENTION

Patent document 1: JP 2004-112044 A
Patent document 2: JP 2007-43653 A (corresponding to US2006/0290590)
Patent document 3: JP 2008-227862 A (corresponding to US2008/0224945)

Patent document 1 discloses an antenna aiming at miniaturization. The antenna is a loop antenna having a radiation conductor shaped of a loop. One terminal end is supplied with the electric power while the other terminal end is coupled with a ground conductor. The loop-shaped conductor includes a meander section and a broad-width section. The meander section is formed in one side of the plate-shaped dielectric member while the broad-width section is formed in the other side. This can provide an effect due to the loop-shaped radiation conductor partially shaped of a meander and an effect of shortening wavelength due to dielectrics. As a result, a line length is earned more, and the miniaturized antenna is realized.

The antenna disclosed in Patent document 1 has the meander section only in the one side of the plate-shaped dielectrics. If such an antenna is applied to an antenna apparatus to use a low frequency band and have a wavelength longer than the physique of the dielectrics, the antenna apparatus cannot resonate only using the meander section to thereby require any means for extending the line length such as an inductor externally inserted. The above antenna apparatus is used, for example, in a wireless apparatus of a keyless remote system used in a vehicle or residence, which uses a comparatively long wavelength (tens of centimeters to several meters) such as UHF and VHF bands. The above means for extending the line length involves the loss due to the outer inductor which does not contribute to radiation, thereby decreasing the radiation gain (antenna gain). Furthermore, if almost the same gain is maintained, it is difficult to miniaturize the dimensions of the antenna. The wavelength shortening effect may be improved by making higher the dielectric constant of the dielectrics to thereby aim at increase in the radiation gain (or miniaturization of the dimensions). In such a case, as the dielectric constant is generally high, the dielectric tangent (tan δ) is high; thus, the radiation gain decreases because of the dielectric loss.

To that end, the Applicant proposes an antenna having the following terminal open type double spiral structure in Patent document 2. The antenna includes two outer and inner elements. One element is a signal line while the other element is a GND line. The outer element and the inner element are prolonged spirally in an axial direction and spaced from each other. The inner element made spiral can provide a double spiral structure to thereby earn an electric length (line length). Thus, the dimensions or physique of the antenna can be miniaturized while the resonance frequency can be obtained by the antenna itself even if the use frequency band is low. The Applicant also proposes another antenna apparatus in Patent document 3. The antenna apparatus contains the configuration of the above antenna in Patent document 2 while maintaining the predetermined positional relationship of the two elements using a support member made of dielectrics. The two elements can be held in the predetermined positional relationship by the support member, and the performance of the terminal open type antenna of the above-mentioned double spiral structure can be held. In addition, the wavelength shortening effect of the high frequency wave current due to the dielectrics can further decrease the resonance frequency.

More specifically, in the antenna of such a terminal open type, the outer and inner elements have terminal ends for input/output signals (referred to as feed point side terminal end, high frequency wave source side terminal end, or connecting terminal end) in the same end portion along the axial direction. In contrast, the other terminal end arranged opposite to the connection terminal end of each element along the axial direction is open. Thereby, the electric current hardly flows into the other terminal end in each element. The wavelength shortening effect due to the dielectrics cannot be expected in the relevant portion of the elements. Therefore, when the above antenna is applied to an antenna apparatus using a lower frequency band while maintaining the dimensions of the antenna, the resonance characteristic cannot be easily obtained by the antenna itself. This results in requiring the use of dielectrics having a higher dielectric constant or the insertion of an inductor as a line extension means.

### SUMMARY OF THE INVENTION

It is an object of the present invention to provide an antenna apparatus having a double spiral structure including an outer element prolonged spirally in an axial direction and an inner element prolonged spirally in the axial direction, the inner element which is arranged inside of and spaced from the outer element. Such an antenna apparatus can provide small dimensions a lower resonance frequency while suppressing a dielectric loss or loss due to an insertion of an inductor.

According to an example of the present invention, an antenna apparatus is provided as follows. The antenna apparatus includes an antenna and support member. The antenna has a double spiral structure to include two elements of (i) an outer element, which has a spiral section prolonged spirally in an axial direction, and (ii) an inner element, which has a spiral section prolonged in the axial direction and surrounded with an interval space by the outer element. The support member includes a dielectric member and contacts each of the spiral sections of the outer and inner elements wholly in a prolonged direction of each element while supporting the outer and inner elements in a predetermined positional relationship. One of the two elements is configured to be coupled with a high frequency wave source at one end portion along the axial direction of the double spiral structure while an other of the two elements is configured to coupled with the high frequency wave source in an other end portion along the axial direction, thereby enabling the antenna to function as a terminal short circuit type antenna.

### BRIEF DESCRIPTION OF THE DRAWINGS

The above and other objects, features, and advantages of the present invention will become more apparent from the following detailed description made with reference to the accompanying drawings. In the drawings:

FIG. 1 is a plan view illustrating an outline configuration of an antenna apparatus according to a first embodiment of the present invention;

FIG. 2 is a perspective view illustrating an outline configuration of an antenna unit;

FIG. 3 is a perspective view illustrating a process of manufacturing an upper part of the antenna unit in a manufacturing process of the antenna apparatus;

FIG. 4 is a perspective view illustrating a process of manufacturing a lower part of the antenna unit in the manufacturing process of the antenna apparatus,

FIG. 5 illustrates a simulation result of an electric current distribution using the FDTD method at the time of operation of the antenna apparatus shown in FIG. 1;

FIG. 6 illustrates an actual measurement of a radiation directivity of the antenna apparatus illustrated in FIG. 1;

FIG. 7 illustrates a simulation result of an electric current distribution using the FDTD method with respect to a terminal open type antenna having a double spiral structure as a comparative example;

FIG. 8 is a diagram illustrating a wavelength shortening effect in the antenna apparatus illustrated in FIG. 1;

FIG. 9 is a diagram illustrating a wavelength shortening effect in a terminal open type antenna having a double spiral structure as a comparative example; and

FIG. 10 is a plan view illustrating an outline configuration of an antenna apparatus according to a second embodiment of the present invention.

### DETAILED DESCRIPTION OF THE PREFERRED EMBODIMENTS

The following describes embodiments of the present invention with reference to drawings.

### First Embodiment

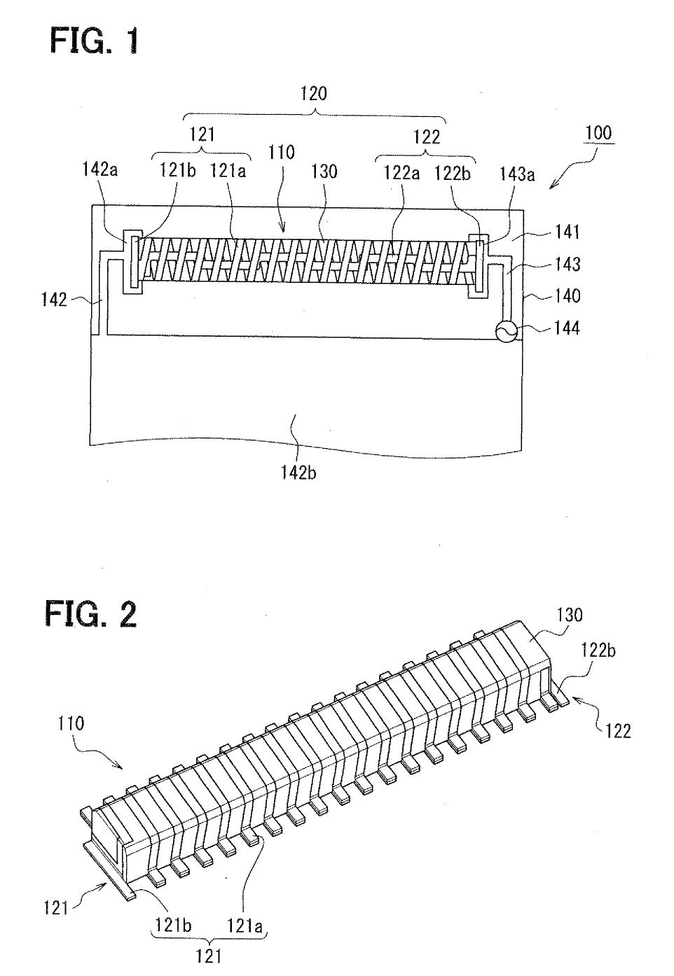

FIG. 1 is a plan view (viewed from a point over a top surface of a substrate) illustrating an outline configuration of an antenna apparatus according to a first embodiment of the present invention. More specifically, in FIG. 1, the part of the inner element, which is actually covered by the support member, is illustrated for convenience. FIG. 2 is a perspective view illustrating an outline configuration of an antenna unit. Furthermore, the antenna apparatus according to the present embodiment is included as a receiver in a keyless remote system for vehicles.

As illustrated in FIG. 1 and FIG. 2, the antenna apparatus 100 includes an antenna unit 110 and a substrate 140, on which the antenna unit 110 is mounted. The antenna unit 110 includes an antenna 120 and a support member 130. Furthermore, the substrate 140 is configured of a base member made of insulating material (for example, a resin base material with a dielectric constant of about three).

The antenna unit 110 is configured by integrating the antenna 120 with the support member 130 supporting the antenna 120. As shown in FIG. 1, the antenna 120 includes an outer element 121 and an inner element 122. The outer element 121 has a spiral section 121a spirally prolonged along (in approximately parallel with) a front surface 141 of the substrate 140. The inner element 122 has a spiral section 122a, which is spirally prolonged in an axial direction of the spiral section 121a of the outer element 121 (hereinafter referred to as “the axial direction” or “axially”) while being arranged inside of the spiral section 121a with an interval space from the spiral section 121a. Each element 121, 122 is connected with a high frequency wave source (alternating voltage source) at the terminal end 121b, 122b, which is also referred to as a mount section 121b, 122b. The terminal end 121b and the terminal end 122b are located in the respective end portions in the mutually different sides in the axial direction of the double spiral structure. That is, the terminal ends for inputting and/or outputting signals of the two elements 121, 122 are separated from each other at the different end portions of the axial direction. Furthermore, each terminal end opposite to each mount section 121b, 122b in each element 121, 122 is open (or free) and not connected with any land.

According to the present embodiment, as illustrated in FIG. 1, the mount section 121b of the outer element 121 is connected with a land 142a of a wire section 142 provided in the front surface 141 of the substrate 140, and connected with the feed point 144 via the wire section 142 containing a GND 142b. The mount section 122b of the inner element 122 is connected with a land 143a of a wire section 143 provided in the front surface 141 of the substrate 140, and connected with the feed point 144 via the wire section 143. Further, those mount sections 121b, 122b are connected via the feed point 144 to the high frequency wave source (transmitting circuit and/or receiving circuit) which is not illustrated.

More specifically, with respect to the two elements 121, 122, the terminal ends of the different sides in the axial direction are arranged in approximately parallel with the front surface 141 of the substrate 140 while configuring the mount sections 121b, 122b, respectively. Each mount section 121b, 122b is arranged on the corresponding land 142a, 143a provided in the front surface 141 of the substrate 140 and connected with the land 142a, 143a via solder (none shown). Thus, when the surface mount structure is adopted as a structure of the mount sections 121b, 122b. It is possible to carry out package mounting of the two elements 121, 122 on the substrate 140 using reflow. The efficiency of mounting of the element 121, 122 to the substrate 140 can be improved. Also in the present embodiment, the package mounting of each element 121, 122 collectively to the substrate 140 is carried out by reflow.

Furthermore, the mode or configuration of the spiral sections 121a, 122a in the two elements 121, 122 is not limited to any specific one. It can be applicable if at least a part of the spiral section 122a of the inner element 122 is contained inside of the spiral section 121a of the outer element 121 with the two spiral sections 121a, 122a spaced (non-contact) from each other. For example, the cross-sectional shape of a spiral of each element 121, 122, may be approximately circular, approximately rectangular, or polygonal other than rectangular. In addition, the number of turns (interval or distance between spiral turns adjoining in the axial direction) of the each of the spiral sections 121a, 122a in each element 121, 122 is not limited to any specific one, either. In the present embodiment, the number of turns n of the spiral section 122a in the inner element 122 is less (n<m) than the number of turns m of the spiral section 121a in the outer element 121. In addition, in the present embodiment, in consideration of the miniaturization of the physique in the axial direction, the length of the spiral sections 121a and 122a are approximately identical while the spiral sections 121a and 122a face each other in the almost whole part in the axial direction. Under such a configuration, the secondary electric current (image electric current) can be induced in the spiral section 122a of the inner element 122 wholly along the axial direction by the electric current which flows in the spiral section 121a of the outer element 121, for example. Furthermore, the elements 121, 122 are arranged such that the central axes thereof are concentrically or coaxial.

Further, as described above, the antenna 120 has a non-contact structure with respect to the two elements 121, 122 such that the inner element 122 is contained inside of the outer element 121 while having a predetermined interval space so as to be spaced from each other. Thus, the positional relationship of the two elements 121, 122 is important to the performance (resonance characteristic) of the antenna 120. As the interval space of the opposed region of the two elements 121, 122 changes, the capacity of the capacitor constructed in the region opposed by the two elements 121, 122 changes to thereby change the resonance frequency and affect the radiation property.

In order to solve such a problem, i.e., in order to maintain the performance of the antenna 120, the support member 130 is arranged to contact each of the spiral sections 121a, 122a of the two elements 121, 122, respectively, to thereby maintain the two elements 121, 122 at a predetermined positional relationship. Thus, the support member 130 allows the central axes of the outer element 121 and inner element 122 to accord with each other. In addition, the support member 130 is constructed of dielectrics (also referred to as a dielectric member). Therefore, the wavelength shortening of the high frequency wave current flowing in the elements 121, 122 (spiral sections 121a, 122a) arises. The resonance frequency of the antenna 120 can be shifted to a lower range compared with the configuration of no dielectrics being integrated.

In the present embodiment, the support member 130 is constructed of the dielectrics, which is a mixed material of resin and ceramic while having a dielectric constant (∈) of 10 having a heat resistance against the reflow mounting. The support member 130 is an approximately rectangular solid having, in the axial direction, a length a little longer than the length of the spiral sections 121a, 122a, as illustrated in FIG. 1 and FIG. 2. For example, the lengths are 24 mm in the axial direction, 3 mm along the front surface 141 of the substrate 140 and orthogonal to the axial direction, and 2 mm in the direction orthogonal to the front surface 141. The whole part of the spiral section 122a of the inner element 122 is arranged inside of the support member 130. That is, the support member 130 is arranged around the spiral section 122a so that the spiral section 122a can be thoroughly covered. In addition, as illustrated in FIG. 2, the spiral section 121a of the outer element 121 is arranged in line with the axial direction so as to wind around a surface (external surface) of the support member 130. In other words, the support member 130 is arranged to intervene between the spiral sections 121a, 122a of the two elements 121, 122 in the whole region in which the two spiral sections 121a, 122a oppose each other. As illustrated in FIGS. 1, 2, the mount section 121b of the outer element 121 is arranged so as to adjoin one end of the support member 130 in the axial direction. In contrast, the mount section 122b of the inner element 122 is exposed from the support member 130 and arranged so as to adjoin the other end of the support member 130 in the axial direction.

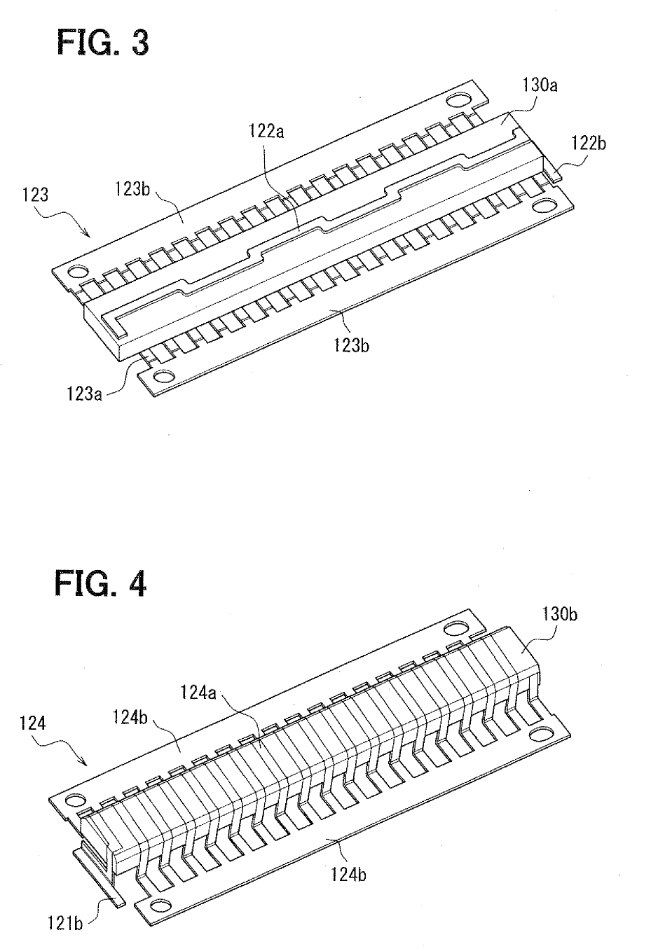

Next, the following explains an example of a method for manufacturing the antenna apparatus 100 having the above configuration. FIG. 3 is a perspective view illustrating a process of manufacturing the upper part of the antenna unit in the manufacturing process of the antenna apparatus. FIG. 4 is a perspective view illustrating a process of manufacturing the lower part of the antenna unit in the manufacturing process of the antenna apparatus. More specifically, the direction indicated by the above “upper” and “lower” signifies an approximately orthogonal direction (hereafter referred to as only “orthogonal direction”) with respect to the front surface 141 of the substrate 140. The lower side is located closer to the front surface 141 while the upper side is located farther from the front surface 141.

First, the two elements 121, 122 constituting the antenna 120, the support member 130, and the substrate 140 are prepared, respectively. According to the present embodiment, the inner element 122 having a predetermined number of turns n is prepared through applying a punch, bend, etc. to a metal plate.

In addition, as illustrated in FIGS. 3, 4, the outer element 121 is prepared by dividing in the orthogonal direction into two parts of a lower element 123a and an upper element 124a. The lower element 123a is a portion of the spiral section 121a arranged on the front surface 141 of the substrate 140. The lower element 123a is prepared as a part of a lead frame 123 by applying punches and bends to the metal plate as illustrated in FIG. 3. Furthermore, the sign 123b illustrated in FIG. 3 is assigned to a connection section 123b which connects the lower element 123a at each end side in the longitudinal direction of the lower element 123a (spiral section 121a). This connection section 123b is unnecessary as the antenna 120; thus, it is removed later. In addition, the upper element 124a corresponds to a part of the outer element 121 excluding the lower element 123a (the mount section 121b and part of the spiral section 121a). The upper element 124a is prepared as a part of a lead frame 124 as illustrated in FIG. 4 by applying punches and bends to a metal plate. Furthermore, the sign 124b illustrated in FIG. 4 is assigned to a connection section 124b which connects respective parts of the spiral section 121a at respective end sides in the longitudinal direction of the upper element 124a. This connection section 124b is unnecessary as the antenna 120, either, thus, it is removed later.

In addition, as illustrated in FIGS. 3, 4, the support member 130 made of dielectrics is prepared by dividing in the orthogonal direction into two parts of a lower support member 130a and an upper support member 130b. The lower support member 130a is formed in the shape of an approximately rectangular solid using the mixed material of resin and ceramics, as described above. The lower support member 130a is provided with a groove (not shown), in which the inner element 122 is inserted, from a top surface to a side surface. Further, the lower support member 130a is provided with a groove (not shown), in which the lower element 123a is inserted, in a bottom surface. The upper support member 130b is also formed in the shape of an approximately rectangular solid using the same material as the lower support member 130a. The upper support member 130b is provided with a groove (not shown), in which the upper element 124a is inserted, from a top surface to a side surface.

Next, while the lower element 123a of the lead frame 123 is inserted into the groove of the lower support member 130a, the inner element 122 is inserted into the corresponding groove. Thus, as illustrated in FIG. 3, the lower support member 130a, the inner element 122, and the lead frame 123 are integrated into a unit. In addition, the upper element 124a of the lead frame 124 is similarly inserted into the groove in the upper support member 130b. Thus, as illustrated in FIG. 4, the upper support member 130b, and the lead frame 124 are integrated into a unit. Then, the lower support member 130a and the upper support member 130b are inserted into each other to thereby be integrated into a unit. Thereby, the spiral section 122a of the inner element 122 is covered with the support member 130. In addition, the lower element 123a and the upper element 124a which constitute the spiral section 121a of the outer element 121 are overlapped at the mutual end portions.

Next, the overlapped portion of the lower element 123a and the upper element 124a is irradiated with the laser beam, and laser welded. After the laser welding, the connection sections 123b, 124b, which are the unnecessary part of the lead frames 123, 124, are removed. The antenna unit 110 illustrated in FIG. 2 is thereby formed.

Next, the solder (not shown) is applied using a screen printing or dispenser on the lands 142a, 143a of the substrate 140 prepared separately. The antenna unit 110 is positioned on the front surface 141 of the substrate 140 such that the mount sections 121b, 122b are arranged on the corresponding lands 142a, 143a. Under the condition that the antenna unit 110 is positioned, the reflow is applied so as to join up the mount sections 121b, 122b and the corresponding lands 142a, 143a via the solder, thereby forming the above-mentioned antenna apparatus 100.

Furthermore, when the antenna unit 110 is arranged on the substrate 140, any point other than the mount sections 121b, 122b may be fixed to the front surface 141 of the substrate 140. Thereby, the mounting structure of the antenna 120 on the substrate 140 can be also stabilized. For example, a part of the outer element 121 (for example, a laser welding portion, or a bottom part of the support member 130) may be used as a connection section, which does not provide an electrical connection function (i.e., non-conductive connection).

Next, the following explains an effect of the antenna apparatus 100 according to the present embodiment. The Applicant made clear the following in Patent document 2. In the antenna in which the inner element is contained inside of the spirally prolonged outer element with an interval space maintained between the two elements, the electric current flowing through the outer element affects the inner element to thereby induce the secondary electric current (image electric current), which is reverse but has the same electric flow amount as the electric current through the outer element. The electric current flowing in the inner element, and secondary electric current are combined to make the current distribution of the inner element in the spiral form. In addition, when the inner element is made spiral, the route of the electric current which has the spiral distribution is secured to thereby increase the electric length while helping prevent the flow of the unnecessary current vector other than the use radio wave. This can downsize the dimensions of the antenna and make lower the antenna's resonance frequency.

Similarly, as explained above, in the present embodiment, the antenna apparatus 100 includes a antenna similar with that in Patent document 2. That is, the antenna 120 is a double spiral structure to have the outer element 121 and the inner element 122. The outer element 121 has the spiral section 121a spirally prolonged along the front surface 141 of the substrate 140. The inner element 122 has the spiral section 122a, which is spirally prolonged in the axial direction and inside of the outer element 121 with an interval space against the outer element 121. The long electric length (line length) can be thus securable while suppressing the length of the antenna 120 in the axial direction. While downsizing the dimensions of the antenna, the antenna's resonance frequency can be made lower.

In addition, also in the present embodiment, because of the antenna 120 having the double spiral structure, at the operation of the antenna 120, the electric current which flows in one element (for example, the outer element 121) induces the secondary electric current (image electric current) in the other element (for example, the inner element 122). Therefore, although the two elements 121, 122 are not mechanically connected with each other, the above configuration is substantively comparable with the case where the two elements are electrically connected. Further, the two elements 121, 122 are connected with the feed point 144 at the respective terminal ends of the mutually different sides in the axial direction. Therefore, the antenna 120 of the double spiral structure containing the two elements 121, 122 functions or operates as a terminal short circuit type antenna (i.e., a loop antenna, a magnetic field type antenna).

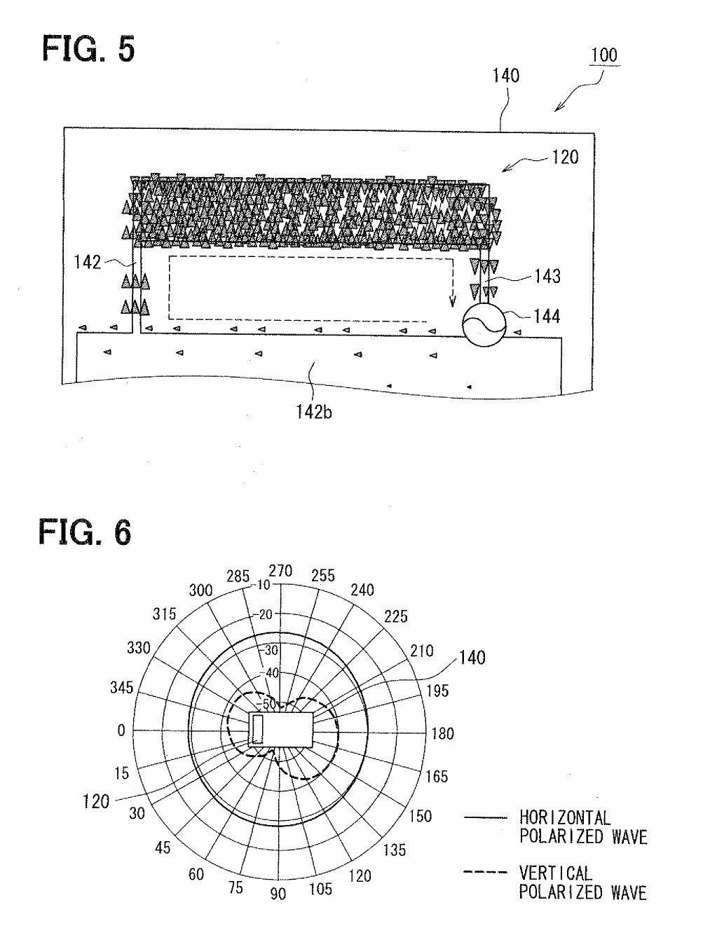

Thus, the antenna 120 according to the present embodiment operates as a terminal short circuit type antenna in the antenna apparatus 100. Such a characteristic was confirmed by the present Inventors. The results are illustrated in FIG. 5 and FIG. 6. FIG. 5 illustrates a simulation result of the current distribution using the FDTD (Finite-Difference Time-Domain) method at the time of operation of the antenna apparatus 100 shown in FIG. 1. FIG. 6 illustrates an actual measurement of the radiation directivity of the antenna apparatus 100 illustrated in FIG. 1. Herein, the solid line illustrates a horizontally polarized wave while the broken line illustrates a vertically polarized wave. Furthermore, the antenna apparatus is set to have a resonance frequency of 314 MHz. The electric length of the antenna 120 integrated with the above-mentioned support member 130 having the dimensions of 24 mm×3 mm×2 mm is set to λ/2. As a result, the electric current flows in the broken line arrow direction (loop shape) shown in FIG. 5. This can explicitly prove that the antenna 120 having the double spiral structure functions as a loop antenna. In addition, as shown in FIG. 6, the vertically polarized wave (horizontal component) has a directivity shaped of an approximately circle, thereby proving that the antenna 120 functions as a loop antenna.

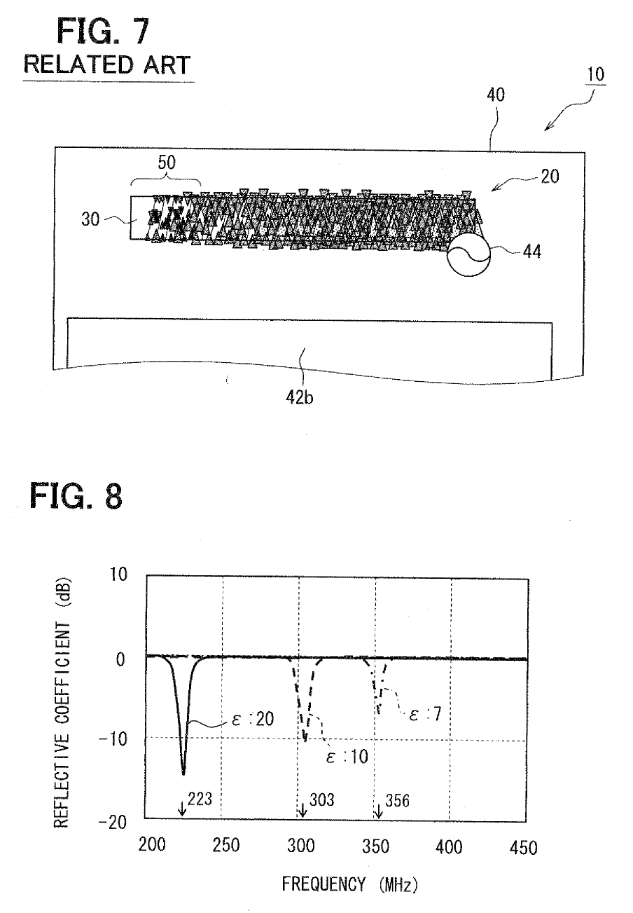

Here, the density of the electric current which flows in each element 121, 122 becomes small as the measured point separates far from the connection terminal end connected with the feed point 144 (high frequency wave source). In other words, the density of the electric current is larger at the measured point closer to the feed point 144. As described above in the present embodiment, the antenna 120 operates as a loop antenna; thus, the electric current is distributed over the whole of the antenna 120 in the axial direction, as illustrated in FIG. 5. This is because the two connection terminal ends connected with the feed point (high frequency wave source) of the two elements are arranged in the separated different end portions with respect to the axial direction so that the distribution tendencies of the electric current flowing in the axial direction of the two elements simply become reverse to each other (except for the influence of secondary electric current). In contrast, the terminal open type antenna (electric field type antenna) of the double spiral structure recited in Patent document 2 provides the following. This is, the two connection terminal ends connected with the feed point (high frequency wave source) of the two elements are arranged in the same end portion with respect to the axial direction so that the tendencies of the current distribution in the axial direction of the respective elements is the same (such tendencies are not changed even if there is influence by the secondary electric current). Thus, with respect to an antenna 20 illustrated in FIG. 7, the current density in the axial direction is large in the end portion near the feed point 44 whereas the electric current hardly flows around the other end portion 50 opposite to the end portion connected with the feed point 44. FIG. 7 illustrates a simulation result of the current distribution using the FDTD method with respect to the terminal open type antenna of the double spiral structure as a comparative example. In FIG. 7, the reference numbers are assigned by subtracting 100 from the reference numbers for the corresponding elements of the present embodiment. Furthermore, the configuration of the antenna apparatus 10 illustrated in FIG. 7 is the same as the configuration illustrated in FIG. 5, except that the connection terminal ends connected with the feed point 44 differ.

Therefore, although the antenna apparatus 100 of the present embodiment has the same double spiral structure, the deviation of the current density in the axial direction is made small; in other words, the portion in which the electric current does not flow is reduced or eliminated, compared with the terminal open type antenna. Thus, the present embodiment can provide the following effect. The support member 130 made of dielectrics contacts the spiral sections 121a, 122a wholly in the prolonged direction of the elements 121, 122. Under such a configuration, the wavelength shortening effect by the dielectric is expectable wholly in the spiral sections 121a, 122a (in the whole of the antenna 120 in the axial direction). According to the present effect, the resonance frequency of the antenna 120 can be further shifted to a lower frequency.

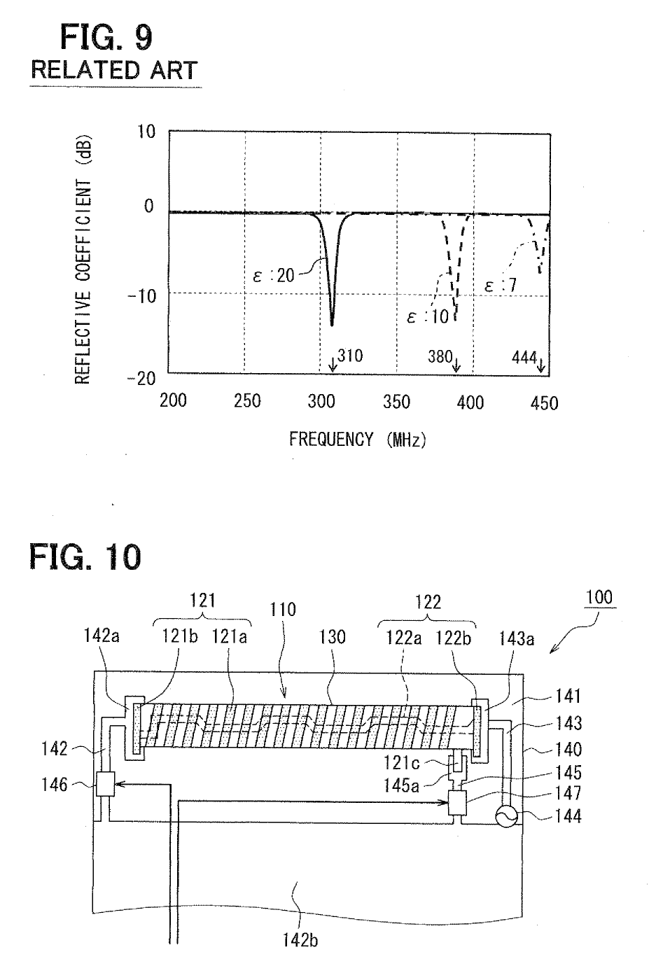

Furthermore, the present inventors confirmed the following. That is, although having the same double spiral structure, the antenna apparatus 100 according to the present embodiment has a resonance frequency further shifted to a lower range compared with the antenna apparatus having a terminal open type antenna, which is illustrated in FIG. 7. The result is illustrated in FIGS. 8, 9. FIGS. 8, 9 illustrate the wavelength shortening effect using the electromagnetic simulation. The horizontal axis indicates a frequency and the vertical axis indicates a reflective coefficient. FIG. 8 corresponds to the antenna apparatus 100 according to the present embodiment. The parameter of the support member 130 having a dielectric constant of 20, 10, or 7 is illustrated by the solid line, broken line, or chain line, respectively. In addition, FIG. 9 corresponds to as a comparative example a terminal open type antenna having a double spiral structure. The parameter of the support member having a dielectric constant of 20, 10, or 7 is illustrated by the solid line, broken line, or chain line, respectively. Furthermore, the configuration of the antenna apparatus in FIG. 9 is the same as that of the present embodiment, except that the connection terminal ends connected with the feed point differ. In other words, the configuration of the spiral section, support member, etc. are the same. FIGS. 8, 9 clearly indicate that, with respect to any dielectric constant, the antenna apparatus 100 having the terminal short circuit type antenna 120 according to the present embodiment has the lower resonance frequency than the antenna apparatus having the terminal open type antenna. For attaining the resonance frequency of about 310 MHz, the antenna apparatus 100 according to the present embodiment requires the dielectric constant of 10 of the dielectric applied to the support member 130. In contrast, the antenna apparatus having the terminal open type antenna of the double spiral structure requires the dielectric constant of 20.

As mentioned above, the antenna apparatus 100 according to the present embodiment has the antenna 120 with a double spiral structure in which the outer element 121 prolonged spirally in the axial direction contains, with an interval space, the inner element 122 spirally prolonged also in the axial direction. Such an antenna apparatus can be small sized and have a lower resonance frequency while suppressing the dielectric loss or loss due to the matching circuit such as an inductor.

In addition, in the present embodiment, the spiral sections 121a, 122a of the two elements 121, 122 which constitute the antenna 120 are prolonged along the front surface 141 of the substrate 140. That is, the antenna 120 is arranged in a direction parallel to the front surface 141 of the substrate 140. Further, as described above, in the antenna apparatus which uses the radio wave having a comparatively long wavelength (tens of centimeters to several meters), the size of the antenna is dominant to the physique or dimensions of the antenna apparatus. In addition, the direction approximately orthogonal to the front surface of the substrate is more influential in the physique of the antenna apparatus than the direction approximately parallel to the front surface. Thus, the physique of the antenna apparatus according to the present embodiment can be miniaturized more effectively than the antenna configuration in which the axial direction of the spiral sections 121a, 122a approximately orthogonal to the front surface 141 of the substrate 140. In addition, the configuration is provided in the present embodiment such that (i) the feed-point 144 connection terminal end (mount section 121b) of the element 121 and (ii) the feed-point 144 connection terminal end (mount section 122b) of the element 122 are arranged so as to be separated from each other at mutually different opposite end portions along the axial direction. Such a configuration can thereby allow the mounting structure of the antenna 120 on the substrate 140 to be simple.

Furthermore, the method for manufacturing of the antenna apparatus 100 concerning the present embodiment is not limited to the above example. Alternatively, an antenna unit 110 may be manufactured in the process in which a metal wire is processed to form two elements 121, 122 for example, and the formed two elements 121, 122 are then inserted in grooves of the support member 130 (130a, 130b). In addition, when carrying out injection molding of the support member 130, at least one of the two elements 121, 122 may be dealt with as an insertion part.

### Second Embodiment

The following describes a second embodiment of the present invention with reference to FIG. 10. FIG. 10 is a plan view (viewed from a point over the surface of the substrate) illustrating an outline configuration of an antenna apparatus according to the second embodiment of the present invention. More specifically, in FIG. 10, the part of the inner element, which is actually covered by the support member, is illustrated using the broken line.

The antenna apparatus according to the second embodiment has a configuration almost similar to that of the first embodiment. Detailed explanation is mainly made with respect to different portions therebetween. Furthermore, the same reference numbers are given to the same elements as the elements illustrated in the first embodiment.

In the first embodiment, the antenna 120 of the double spiral structure containing the two elements 121, 122 functions or operates as only a terminal short circuit type antenna (i.e., a loop antenna, a magnetic field type antenna). In contrast, as the characteristic of the present second embodiment, the antenna having the double spiral structure 120 functions as a terminal short circuit type antenna (i.e., a loop antenna, a magnetic field type antenna) at a predetermined time condition (also referred to a predetermined timing) and, furthermore, functions as a terminal open type antenna (electric field type antenna) at a time condition different from the foregoing predetermined time condition. That is, it is characterized that the magnetic field type antenna and the electric field type antenna can be used alternately.

As illustrated in FIG. 10, the inner element 122 among the two elements 121, 122 included in the antenna 120 is connected, at a mount section 122b, with the facing land 143a of the wire section 143 in only one end portion in the axial direction similar to the antenna apparatus 100 illustrated in the first embodiment.

In contrast, the outer element 121 is connected, at a mount section 121b opposite to the mount section 122b, with the land 142a of the wire section 142 in the other end portion of the axial direction similarly with that illustrated in the first embodiment. In addition, the outer element 121 is further connected, at a mount section 121c, with a land 145a of a wire section 145 provided in the front surface 141 of the substrate 140. The mount section 121c is arranged at the side opposite to the mount section 121b (at the same side as the mount section 122b of the inner element 122). The wire section 145 is connected with the feed point 144 via the GND 142b like the wire section 142. That is, the GND 142b is a part of the wire section 142, which connects the feed point 144 with the mount section 121b, while the GND 142b is a part of the wire section 145, which connects the feed point 144 with the mount section 121c. Thus, in the present embodiment, the both terminal ends of the outer element 121 serve as the mount sections 121b, 121c on the substrate 140 (connection terminal ends connected with the feed point 144).

In addition, two switching elements 146, 147 are provided in the middle of the wire sections 142, 145, which are connected with the mount sections 121b, 121c (both terminal ends) of the outer element 121, respectively. The switching elements 146, 147 permits or prevents the flow of the electric current in the ON state or the OFF state, respectively. That is, the mount section 121b is connected with the feed point 144 via the switching element 146, while the mount section 121c is connected with the feed point 144 via the switching element 147. Furthermore, in the present embodiment, the switching element 146, 147 is arranged between the GND 142b and each land 142a, 145a in the wire section 142, 145, respectively. Further, the ON/OFF state of the switching element 146, 147 is switched therebetween by an instruction signal from an ECU or the like (not shown).

More specifically, when the switching element 146 is in the ON state and the switching element 147 is in the OFF state, the outer element 121 is connected with the feed point 144 at the mount section 121b, which is arranged along the axial direction in the end portion opposite to the mount section 122b. That is, the two elements 121, 122 are respectively connected with the feed point 144 at the different end portions along the axial direction, thus, as indicated in the first embodiment, the antenna 120 functions as a terminal short circuit type antenna (loop antenna, magnetic field type antenna). Further, when the switching element 146 is in the OFF state and the switching element 147 is in the ON state, the outer element 121 is connected with the feed point 144 at the mount section 121c, which is arranged along the axial direction in the same end portion as the mount section 122b. That is, the two elements 121, 122 are respectively connected with the feed point 144 at the same end portion along the axial direction; thus, the antenna 120 functions as a terminal open type antenna (electric field type antenna).

Thus, in the antenna apparatus 100 according to the present embodiment, one antenna 120 can be operated as either the terminal short circuit type antenna or the terminal open type antenna. That is, the magnetic field type antenna and the electric field type antenna can be used alternately. In addition, as explained in the first embodiment (refer to FIGS. 8, 9), even when the terminal short circuit type antenna and the terminal open type antenna have the same configuration of the antenna unit 110, the corresponding resonance frequencies differ from each other. That is, the terminal short circuit type has a lower resonance frequency than the terminal open type. The antenna apparatus 100 can be therefore used at multiple frequencies even without using a matching circuit such as an inductor.

Further, in the present embodiment, only the outer element 121 among the two elements 121, 122 is mounted at the both end portions along the axial direction; further, the terminal for inputting and/or outputting signals in the outer element 121 is switched between the two mount sections 121b, 121c. Alternatively only the inner element 122 may be mounted at the both ends; further, the terminal for inputting and/or outputting signals in the inner element 122 may be switched between the two mount sections. More specifically, the switching element may be provided in the middle of the wire section between each mount section and the feed point 144.

The preferred embodiment of the present invention is thus described; however, without being restricted to the embodiment mentioned above, the present invention can be variously modified as long as not deviating from the scope thereof.

The present embodiment indicates an example in which the antenna apparatus 100 is applied to the in-vehicle keyless receiver. However, the antenna apparatus 100 may be applied without limited to the above example. It is also applicable to another antenna apparatus such as a smart entry system. In addition, needless to say, it may be applicable not only to the receiver but also to the transmitter.

The present embodiment explains the example in which the spiral section 122a of the inner element 122 is covered by the support member 130 made of the dielectrics and the spiral section 121a of the outer element 121 winds around the external surface of the support member 130. However, the configuration of the support member 130 is not limited to the above example. The support member 130 is only required to contact the spiral sections 121a, 122a wholly in the prolonged direction of the elements 121, 122.

The present embodiment explains the example in which the wire section 142 for connecting the feed point 144 and the mount section 121b of the outer element 121 includes the GND 142b. However, the configuration not having the GND 142b may be applicable.

Aspects of the disclosure described herein are set out in the following clauses.

According to an aspect of the disclosure, an antenna apparatus is provided as follows. The antenna apparatus includes an antenna and support member. The antenna has a double spiral structure to include two elements of (i) an outer element, which has a spiral section prolonged spirally in an axial direction, and (ii) an inner element, which has a spiral section prolonged in the axial direction and surrounded with an interval space by the outer element. The support member includes a dielectric member and contacts each of the spiral sections of the outer and inner elements wholly in a prolonged direction of each element while supporting the outer and inner elements in a predetermined positional relationship. One of the two elements is configured to be coupled with a high frequency wave source at one end portion along the axial direction while an other of the two elements is configured to coupled with the high frequency wave source in an other end portion along the axial direction, thereby enabling the antenna to function as a terminal short circuit type antenna.

According to the above configuration, two elements contained in the antenna are both shaped spiral and formed as a double spiral structure to secure a long electric length while downsizing the dimensions of the antenna and making lower the antenna's resonance frequency.

In addition, the spiral section of the inner element is arranged inside of the spiral section of the outer element; thus, the electric current which flows in one element induces secondary electric current (image electric current) in the other element. That is, although the two elements are not mechanically connected with each other, the above configuration is substantively comparable with the case where the two elements are electrically connected. Further, the two elements are connected with the high frequency wave source (i.e., feed point) at the respective terminal ends arranged in the mutually different respective end portions along the axial direction. Therefore, the antenna containing the two elements functions or operates as a terminal short circuit type antenna (i.e., a loop antenna, a magnetic field type antenna). Such a point is confirmed by the present Inventors.

More specifically, the density of the electric current which flows in each element becomes smaller as the corresponding measured position separates farther from the terminal end connected with the high frequency wave source (feed point). In the above configuration of the aspect of the disclosure, the terminal ends connected with the high frequency wave source in the two respective elements are separated from each other in the respective end portions of the different sides in the axial direction; thus, the antenna operates as a loop antenna. Therefore, the electric current can substantively flow in the antenna wholly along the axial direction, and the deviation of the current density in the axial direction in the antenna becomes small compared with the terminal open type antenna (electric field type antenna) having a double spiral structure. Further, the support member made of dielectrics contacts the spiral sections wholly in the prolonged direction of each element. Therefore, the wavelength shortening due to the dielectrics arises in the whole spiral section (or the whole of the antenna in the axial direction). According to the present effect, the resonance frequency of the antenna can be further shifted to a lower frequency range.

As mentioned above, the antenna apparatus according to the present aspect has an antenna having a double spiral structure in which an outer element and inner element are spirally prolonged coaxially (i.e., in an axial direction of the outer element) such that the inner element is surrounded by and spaced from the outer element with an interval space therebetween. Such an antenna apparatus can be small sized and have a lower resonance frequency while suppressing a dielectric loss or loss due to the matching circuit such as an inductor.

As an optional aspect, the above antenna apparatus may be further provided as follows. With respect to the one of the two elements, one terminal end in the one end portion along the axial direction is coupled with the high frequency wave source via a first switching element while an other terminal end in the other end portion along the axial direction is coupled with the high frequency wave source via a second switching element. With respect to the other of the two elements, one terminal end in the one end portion along the axial direction is coupled with the high frequency wave source. At a predetermined time condition, the first switching element in the one end portion is switched in an OFF state and the second switching element in the other end portion is switched in an ON state such that the one of the two elements is coupled with the high frequency wave source via the other end portion along the axial direction and the other of the two elements is coupled with the high frequency wave source via the one end portion along the axial direction to enable the antenna to function as a terminal short circuit type antenna. At a time condition different from the predetermined time condition, the first switching element is switched in the ON state and the second switching element is switched in the OFF state such that the two elements are coupled with the high frequency wave source via the same one end portion along the axial direction to enable the antenna to function as a terminal open type antenna.

Under the above configuration, of the two elements, one element has terminal ends, each of which can function as a connection terminal end connected with the high frequency wave source (feed point) such that a switching element intervenes between each connection terminal end and the high frequency wave source. When the two elements are connected with the high frequency wave source at the respective terminal ends, which are arranged in the mutually different end portions along the axial direction based on ON/OFF states of each switching element, the antenna can functions as a terminal short circuit type antenna. In addition, when the two elements are connected with the high frequency wave source at the terminal ends of the same end portion along the axial direction, the antenna can be operated as an antenna of the terminal open type. Thus, one antenna can be operated as either a terminal short circuit type or termination open type. The antenna apparatus can be therefore used at multiple frequency bands even without using a matching circuit such as an inductor.

As an optional aspect, the above antenna apparatus may further comprise a substrate to which the antenna is mounted, the substrate having a land corresponding to a terminal end of the elements connected with the high frequency wave source such that a surface forming the land in the substrate is approximately parallel with the axial direction of the spiral sections in the two elements.

The above configuration can simplify the mounting structure of the antenna onto the substrate in the configuration where the respective connection terminal ends connected with the high frequency wave source (feed point) in the two elements are separated from each other in the end portions of the opposite sides along the axial direction.

Further, for instance, a wireless apparatus as an antenna apparatus for a keyless remote system (i.e., a so-called keyless receiver) uses a comparatively long wavelength (tens of centimeters to several meters) such as UHF or VHF band. In such an antenna apparatus, the size or dimensions of the antenna is dominant to the physique or dimensions of the whole antenna apparatus. Further, the direction approximately orthogonal to the land formation surface in the substrate affects much more the dimensions of the antenna apparatus than the direction approximately parallel with the land formation surface. To that end, under the above configuration of the optional aspect, the axial direction of the spiral sections in the two elements is approximately parallel with the land formation surface of the substrate; thus the physique of the antenna apparatus can be miniaturized more effectively.

It will be obvious to those skilled in the art that various changes may be made in the above-described embodiments of the present invention. However, the scope of the present invention should be determined by the following claims.

What is claimed is:

1. An antenna apparatus comprising:
an antenna coupled with a high frequency wave source, the antenna having a double spiral structure to include two elements of (i) an outer element, which has a spiral section prolonged spirally in an axial direction, and (ii) an inner element, which has a spiral section prolonged in the axial direction and surrounded with an interval space by the outer element; and
a support member including a dielectric member and contacting each of the spiral sections of the outer and inner elements while supporting the outer and inner elements in a predetermined positional relationship, the support member contacting the spiral sections wholly in a prolonged direction of each element,
one of the two elements configured to be coupled with the high frequency wave source at one end portion along the axial direction while an other of the two elements configured to coupled with the high frequency wave source in an other end portion along the axial direction, thereby enabling the antenna to function as a terminal short circuit type antenna.

2. The antenna apparatus according to claim 1, wherein:
with respect to the one of the two elements, one terminal end in the one end portion along the axial direction is coupled with the high frequency wave source via a first switching element while an other terminal end in the other end portion along the axial direction is coupled with the high frequency wave source via a second switching element;
with respect to the other of the two elements, one terminal end in the one end portion along the axial direction is coupled with the high frequency wave source;
at a predetermined time condition, the first switching element in the one end portion is switched in an OFF state and the second switching element in the other end portion is switched in an ON state such that
the one of the two elements is coupled with the high frequency wave source via the other end portion along the axial direction and
the other of the two elements is coupled with the high frequency wave source via the one end portion along the axial direction
to enable the antenna to function as a terminal short circuit type antenna; and
at a time condition different from the predetermined time condition, the first switching element is switched in the ON state and the second switching element is switched in the OFF state such that
the two elements are coupled with the high frequency wave source via the same one end portion along the axial direction
to enable the antenna to function as a terminal open type antenna.

3. The antenna apparatus according to claim 1, further comprising:
a substrate to which the antenna is mounted, the substrate having a land corresponding to a terminal end of the elements connected with the high frequency wave source such that a surface forming the land in the substrate is approximately parallel with the axial direction of the spiral sections in the two elements.
